(19) United States
(12) Patent Application Publication
(10) Pub. No.: US 2015/0286796 A1
(43) Pub. Date: Oct. 8, 2015

(54) METHOD AND SYSTEM FOR TREATING A DISEASE USING COMBINED RADIOPHARMACEUTICALS

(71) Applicant: THE JOHNS HOPKINS UNIVERSITY, Baltimore, MD (US)

(72) Inventors: Robert Hobbs, Baltimore, MD (US); George Sgouros, Ellicott City, MD (US); Richard L. Wahl, Baltimore, MD (US)

(21) Appl. No.: 14/438,132

(22) PCT Filed: Oct. 25, 2013
(86) PCT No.: PCT/US13/66872

§ 371 Date: Apr. 23, 2015

Related U.S. Application Data
(60) Provisional application No. 61/719,283, filed on Oct. 26, 2012.

(51) Int. Cl. G06F 19/00

(52) U.S. Cl. CPC G06F 19/3443; G06F 19/322

(57) ABSTRACT

A method and system of treating a disease for a patient, comprising assigning class data related to a class of patients that have characteristics similar to a specific patient and/or accessing patent data related to the specific patient; and optimizing a treatment plan, the optimizing being determined utilizing properties of a radio-pharmaceutical used to treat the patient and the class data and/or the patient data.

### CROSS-REFERENCE TO RELATED APPLICATIONS

This application claims priority to U.S. provisional application 61/719,283, filed Oct. 26, 2012, which is herein incorporated by reference.

This application incorporates by reference U.S. patent application Ser. No. 12/514,853, filed May 14, 2009; Ser. No. 12/687,670, filed Jan. 14, 2010; Ser. No. 12/690,471, filed Jan. 20, 2010; Ser. No. 12/820,852, filed Jun. 22, 2010 and Ser. No. 13/335,565, filed Dec. 22, 2011.

This invention was made with government support under CA116477, awarded by the NIH. The government has certain rights in the invention

### BRIEF DESCRIPTION OF THE DRAWINGS

FIG. 1 illustrates a system for treating a disease, according to an embodiment.

FIG. 2 illustrates a method for treating a disease using combined radiopharmaceuticals, according to an embodiment.

FIGS. 3A and 3B illustrate examples of possible solutions shown graphically, according to embodiments of the invention.

FIGS. 4 and 5 are example table that may be used in the method for treating a disease, according to embodiments of the invention.

FIG. 6 is an example of how a tumor dose and BED may be plotted as a function of AB, according to an embodiment.

FIG. 7 is an example of how optimal values for tumor control matches that obtained at the intersection of the two MTBED curves (of FIGS. 3A and 3B), according to embodiments of the invention.

### DETAILED DESCRIPTION OF EMBODIMENTS OF THE INVENTION

A method for treating a disease using combined radiopharmaceuticals is set forth herein. The disease may be any disease, comprising: an immunological disease, an infectious disease, cancer, arthritis, or tuberculosis, or any combination thereof.

The systems and methods described herein may use one or more computers. A computer may be any programmable machine capable of performing arithmetic and/or logical operations. In some embodiments, computers may comprise processors, memories, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant art, such as servers, processing devices, PCs, mobile devices, and other terms. It will be understood by those of ordinary skill that those terms used herein are interchangeable, and any computer capable of performing the described functions may be used. For example, though the term “server” may appear in the following specification, the disclosed embodiments are not limited to servers.

Computers may be interconnected via one or more networks. A network may be any plurality of completely or partially interconnected computers wherein some or all of the computers are able to communicate with one another. It will be understood by those of ordinary skill that connections between computers may be wired in some cases (i.e. via Ethernet, coaxial, optical, or other wired connection) or may be wireless (i.e. via WiFi, WiMax, or other wireless connection). Connections between computers may use any protocols, including connection oriented protocols such as TCP or connectionless protocols such as UDP. Any connection through which at least two computers may exchange data may be the basis of a network.

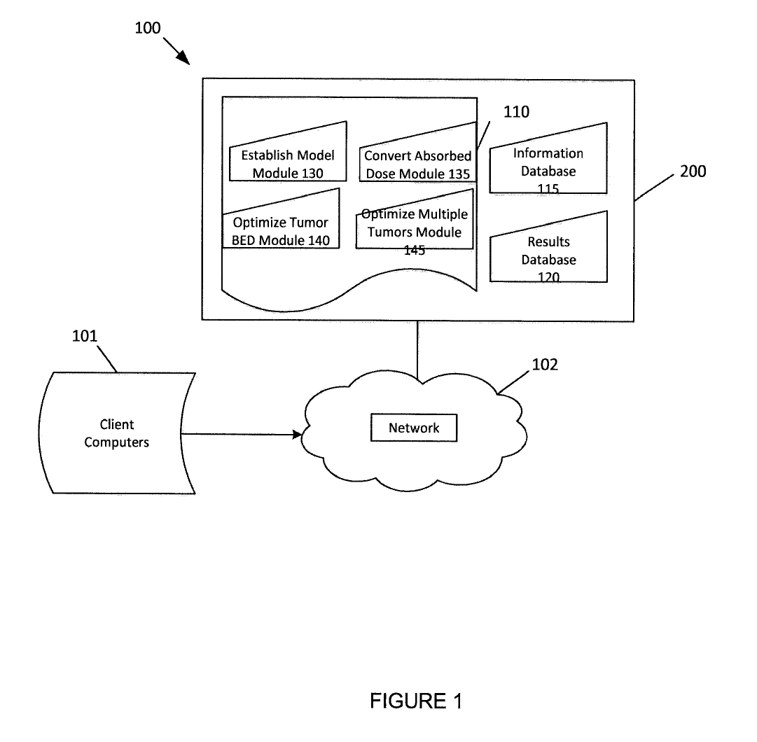

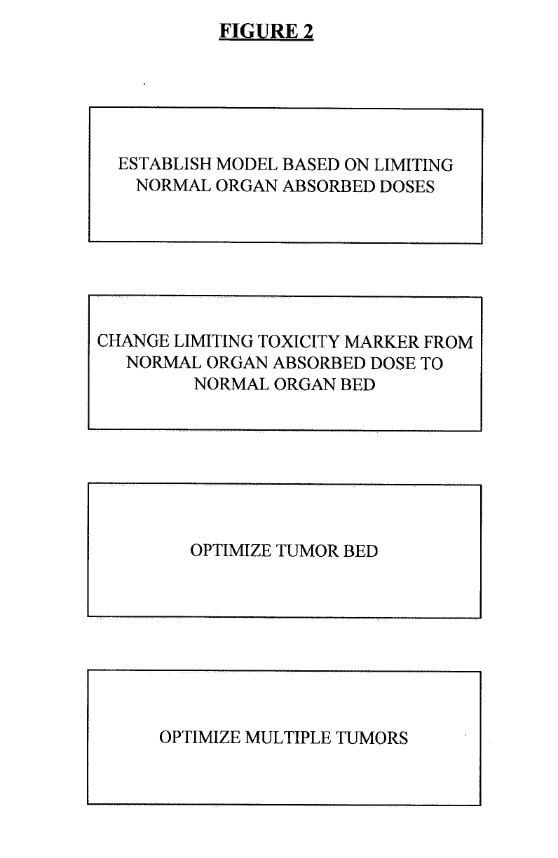

FIG. 1 depicts a system 100 according to an embodiment of the invention. Elements of the system 100 may enable the display of information. The system 100 of FIG. 1 may comprise one or more computers in communication with one another via a network 102 such as the internet. Those of ordinary skill in the art will appreciate that other embodiments may comprise computers that are interconnected via other types of networks. One or more of the computers may be client computers 101. Client computers 101 may be personal computers or handheld devices including web browsers, for example. Information may be displayed on, for example, a large personal computer screen, a smaller mobile phone screen, or displays of any size in between which may be associated with a client computer 101. One or more of the computers may be servers 200, which may communicate with the client computers 101. A server 200 may receive and process information. In some embodiments, the server 200 may also display information and a client computer 101 may not be necessary. In other embodiments, the client computer 101 may display information. The server 200 in this embodiment may be in communication with the network 102. In some embodiments, the server 200 may comprise a treatment application 110 and an information database 115 and a results database 120. The information database 115 may be utilized to pull information to enter into the formulas set forth below. The results database 120 may be used to store results found by the treatment application 110. The treatment application 110 may comprise an establish model module 130, a convert absorbed dose module 135, an optimize tumor BED module 140, or an optimize multiple tumors module 145, or any combination thereof. The functions of the treatment application's modules are described in greater detail with respect to FIG. 2 below. (Note that, in other embodiments, the treatment application 110 and/or the databases may reside at the client computer 101. In additional embodiments, some of the modules of the treatment application and/or database(s) may reside at the server 200 and some may reside at the client computer 101.) It will be understood by those of ordinary skill in the relevant art that components may be omitted, changed, and/or added in various embodiments. In some cases, the components and/or modules may be distributed among multiple computers. It will be further understood by those of ordinary skill in the relevant art that different components and/or modules may perform the functions described below than those shown in this figure.

In an embodiment, the treatment application accesses class data related to a class of patients that have characteristics similar to a specific patient and/or patient data related to the specific patient. The treatment application may then optimize a plan treatment using: properties of a radiopharmaceutical used to treat the patient; and the class data and/or the patient data. In some embodiments, the treatment plan may be optimized using one radiopharmaceutical. In other embodiments, the treatment plan may be optimized using more than one radiopharmaceutical. Radiopharmaceuticals emitting beta-particles, alpha-particles, or auger electrons, or any combination thereof may be used. Radiopharmaceuticals emitting beta-particles of different energy may be utilized in some embodiments.

In some embodiments, the treatment plan may be updated over a time frame based on how the class data and the patient data change over time. A time frame may comprise hours, days, months, or years, or any combination thereof.

The class data and/or the patient data may comprise: tumor properties, normal organ characteristics, organ and/or tumor imaging, organ and/or tumor measurement data, literature data, clinical data, pre-clinical data, or in vivo processing data, or any combination thereof. The class data and/or the patient data may also comprise: biological therapy information, chemotherapy information, targeted pharmaceutical information, and/or deoxyribonucleic acid (DNA) repair or repair pathway information such as poly ADP ribose polymerase (PARP), anti-metabolite use information, dosimetry information, biological response modifiers, anti-vascular agents, anti-inflammatory agents, signal transduction pathway inhibitors, or stem cell support level dose information, or any combination thereof

The radiopharmaceutical property information may comprise: emissions range data, emission type data, half-life data, radiopharmaceutical metabolism data, routed excretion data, emissions spectrum data, emissions energy data, data related to timing and repetition of administration of the pharmaceutical, treatment schedule data, or data related to different routes of administration, or any combination thereof.

FIG. 2 illustrates an example method for combined targeted radiopharmaceutical therapy, according to an embodiment. The example of FIG. 2 simultaneously accounts for 1) radiobiological normal organ tolerance while 2) optimizing the ratio of two different radiopharmaceutical required to maximize tumor control. By plotting the limiting normal organ constraints as a function of the administered activities (AAs) and calculating tumor biological effective dose (BED) along the normal organ maximum tolerated biologic effective doses (MTBED) limits, the optimal combination of activities may be obtained. This treatment may be applied within the framework of a 3-dimensional personalized dosimetry software package, 3D-RD. In this way, it is possible to personalize the therapy to the individual patient.

In addition, this method includes radiobiological quantities for normal organ constraints (BED) and the tumor target (EUBED), which may be more relevant to biological endpoints. Additionally, using the 3D-RD software allows this method to be implemented within clinical time frames.

Furthermore, a graphical representation of the results may allow for easy understanding of the quantitative effects of deviations from the optimal solutions (e.g., the knowledge of how much tumor BED is lost by choosing different AAs is available). In some embodiments, clinical or practical considerations may override suggested AAs. For example, such considerations may comprise: (a) availability of large amounts of one of the radiopharmaceuticals, (b) concerns over radiation safety issues from large quantities of ¹³¹I, and/or (c) the desire for a minimum AA for one or both (or more) radiopharmaceuticals. Because one can visually quantify how much such clinical or practical considerations might affect the dosimetric end point, the treating physician may be able to better balance the different considerations when choosing the therapy AAs.

The example set forth in this application optimizes the administration of ¹³¹I-tositumomab and ⁹⁰Y-ibritumomab tiuxetan for treatment of lymphoma at myeloablative doses. However, those of ordinary skill in the art will see that this method may be used with any combination of therapeutics whose toxicities are orthogonal. It may be dosimetrically-driven, and more specifically, may be founded on radiobiological modeling and the linear-quadratic formalism. In addition, those of ordinary skill in the art will see that this method of combining therapies may be used to treat many diseases other than cancer, comprising: an immunological disease, an infectious disease, arthritis, or tuberculosis, or any combination thereof.

More than one radiopharmaceutical may be used because different radiopharmaceuticals may have differences in cell killing ability depending on the size of the tumors targeted as well as different biodistribution and radiation delivery in the human body. A combination of multiple radioantibody therapies may be more effective than any treatment alone. The combination may target a wider range of tumor diameters because many patients have tumors of a range of sizes from microscopic to multi-cm. In addition, the combination may permit a greater total absorbed dose to the tumor target(s). In myeloablative regimens, dose limiting radiation toxicity is to different critical organs, and substantial doses of more than one agent may be given safely in combination to humans with stem cell support without added toxicity to normal tissues but with increased radiation dose to tumors.

With respect to FIG. 2, in 205, a model may be established based on limiting normal organ absorbed doses. The endpoint may be the AAs that deliver the MTD to both organs simultaneously. In 210, the limiting toxicity marker may be changed from normal organ absorbed dose to normal organ BED; the endpoint AAs may now treat both limiting organ MTBEDs. In 215, the optimization may be changed from toxicity to response by optimizing the tumor BED, which may be guided by the constraints set up by the formalism established in 210. In 220, optimization of multiple tumors may be allowed by calculating the disease EUD and optimizing in the same manner set forth in 215.

Details of establishing a model based on limiting normal organ absorbed doses, as set forth in 205 of FIG. 2, are now explained. Establish model module 130 may be used to help accomplish 205, and may comprise the following functions. The mathematical modeling for the constraints imposed by normal organ toxicity for combined radioimmunotherapy (RIT) has been previously developed in the context of non-myeloablative neuroendocrine tumor therapy, where the limiting organs were the red marrow (for ¹³¹I-MIBG) and the kidneys (for ⁹⁰Y-DOTATOC). For NHL, the typical constraints for myeloablative ¹³¹I-tositumomab, or Bexxar (B) and ⁹⁰Y-ibritumomab tiuxetan, or Zevalin (Z) are the lungs (lu) and liver (li), respectively, with kidneys (ki) as a concern for Bexxar in patients whose lungs are not dose-limiting. Using this formalism and given the maximum tolerated absorbed dose (MTD) constraint values and the dose per unit of administered activity, d, to the two primary limiting organs, a system of two equations and two unknowns may be set up and solved for the amount of injected activities of ¹³¹I-tositumomab, A_{B}, and ⁹⁰Y-ibritumomab tiuxetan, A_{Z}, in an analogous manner, as shown in example Equation (1):

$$\{ \begin{matrix}{MTD}_{lu} = {A}_{Z} {d}_{Z , lu} + {A}_{B} {d}_{B , lu} \\ {MTD}_{li} = {A}_{Z} {d}_{Z , li} + {A}_{B} {d}_{B , li}\end{matrix} \qquad ( 1 )$$

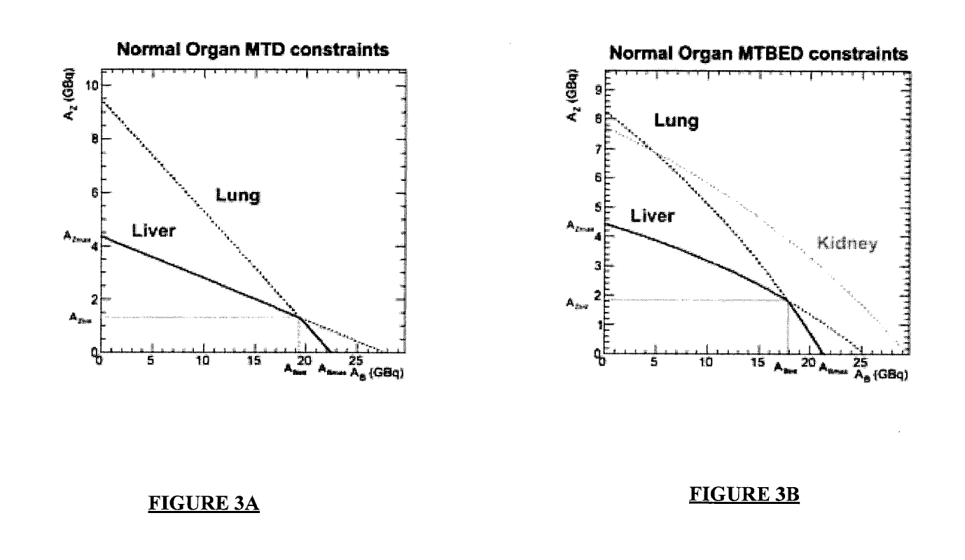

Equation (1) may be considered as two equations with two unknowns (A_{Z} and A_{B}) Both equations may be written as inequalities. However, from an optimization standpoint, the limiting values may be the values of interest. The d values may be taken from previously published patient data for ¹³¹I-tosituimomab (e.g., see Hobbs, R F et al., Arterial wall dosimetry for non-Hodgkin lymphoma patients treated with radioimmunotherapy. J Nucl Med. March 2010; 51(3):368-375, which is herein incorporated by reference) and ⁹⁰Y-ibritumomab tiuxetan (e.g., see Frey E. et al. Estimation of post-therapy marrow dose rate in myeloablative Y-90 ibritumomab tiuxetan therapy. J Nucl Med. 2006; 47(Supplement 1):156P, which is herein incorporated by reference). An MTD value of 27 Gy may be chosen for both the liver and the lungs. An example of possible solutions is illustrated graphically in FIG. 3A, which illustrates optimization based on normal organ BED constraints in A_{B versus A}_{Z} plots. As indicated in FIG. 3A, one line may show the lungs constraint, and another line may show the liver constraint. The lines may be solid when they represent the activity limiting constraint. The dotted line constraints may be automatically satisfied by the solid line criteria. The limiting constraints may also be shown.

Details related to changing the limiting toxicity marker from normal organ absorbed dose to normal organ BED and treating both limiting organ MTBEDs, as set forth in 210 of FIG. 2, are now explained. Convert absorbed dose module 135 may be used to help accomplish 210, and may comprise the following functions. The biological effective dose (BED) may relate absorbed dose and absorbed dose rate to the biological effect it will have if the total absorbed dose were delivered at an infinitesimally low dose-rate. Conversion of absorbed doses to BED also allows comparison of tolerance limits in radiopharmaceutical therapy with experience in radiotherapy. BED has been shown to be predictive of toxicity thresholds in normal organs. Consequently, a model which incorporates radiobiology and more specifically the BED into its constraints may be more likely to be successful in limiting toxicity. An example formula for the BED is set forth in Equation (2).

$$BED = D ( 1 + \frac{G ( ∞ )}{α / β} \cdot D ) \qquad ( 2 )$$

where α and β are the organ specific radiobiological parameters from the linear quadratic model of cell survival, D is the absorbed dose, and G(∞) is the Lea-Catcheside G-factor set forth in example Equation (3):

$$G ( ∞ ) = \frac{2}{{D}^{2}} \cdot {\int }_{0}^{∞} \dot{D} ( t ) d t {\int }_{0}^{t} \dot{D} ( w ) \cdot {e}^{- μ ( t - w )} d w \qquad ( 3 )$$

Here μ is the DNA repair constant, assuming exponential repair and t and w are integration variables. Example Equation (4) illustrates a simple exponential fit of the dose rate, \dot{D}, as a function of time:

\dot{D}(t)=\dot{D}₀e^{-λt} (4)

which may be typical for normal organ kinetics for both ¹³¹I-tosituimomab and ⁹⁰Y-ibritumomab tiuxetan individually, the Lea-Catcheside factor reduces to example Equation (5):

$$\frac{λ}{λ + μ} \qquad ( 5 )$$

where λ is the exponential dose rate decay rate from Equation (4). The normal organ maximum tolerated BED (MTBED) values may constrain the A_{Z} and A_{B} administered activities according to example Equation (6):

$${MTBED}_{i} = ( {A}_{Z} {d}_{Z , i} + {A}_{B} {d}_{B , i} ) ( 1 + {G ( ∞ )}_{i} \cdot \frac{{A}_{Z} {d}_{Z , i} + {A}_{B} {d}_{B , i}}{{α}_{i} / {β}_{i}} ) \qquad ( 6 )$$

where the index i may stand for any dose-limiting organ and the d values may still represent the absorbed dose per unit activity of Bexxar (B) or Zevalin (Z) for the respective organ i. The dose rate may now be a sum of the two (B and Z) exponential dose rate functions and no longer a simple exponential. The G-factor may thus be set forth in Equation (7):

$${G ( ∞ )}_{i} = \frac{1}{{( {A}_{Z} {d}_{Z , i} + {A}_{B} {d}_{B , i} )}^{2}} ( \frac{{A}_{Z}^{2} {d}_{Z , i}^{2} {λ}_{Z , i}}{{λ}_{Z , i} + {μ}_{i}} + \frac{{A}_{B}^{2} {d}_{B , i}^{2} {λ}_{B , i}}{{λ}_{B , i} + {μ}_{i}} ) \qquad ( 7 )$$

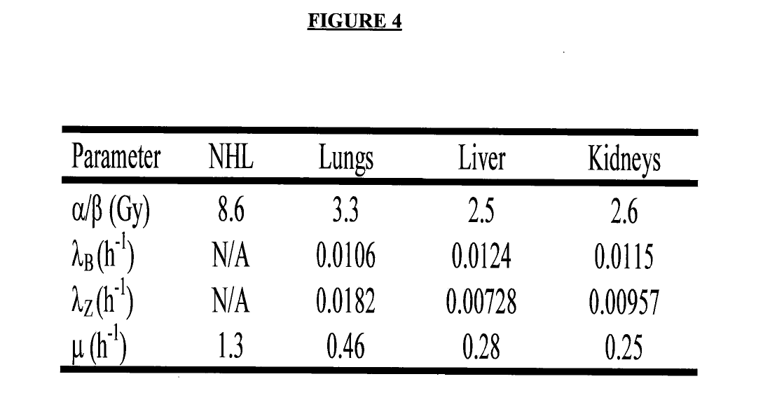

Note that the values used for the radiobiological parameters α/β and μ may be found in the example table of FIG. 4.

Equation (6) may be quadratic in A_{Z} (and A_{B}). By solving for A_{Z} and plotting as a function of A_{B} (or vice versa), a graphical representation of Equation (6) may be obtained, as shown in FIG. 3B, which illustrates optimization based on MTBED constraints in A_{B} versus A_{Z} plots. As indicated on FIG. 3A, one line may show the lungs constraint, another line may show the liver constraint, and a third line may be for the kidneys. The lines may be solid when they represent the activity limiting constraint. The dotted line constraints may be automatically satisfied by the solid line criteria. The limiting constraints may also be shown. The same measured patient parameters used for FIG. 3A may be used, but with MTBED constraints of 30 Gy for the lungs and 35 Gy for the liver. Note that the kidneys may be included as a possible limiting organ although in this illustrative example the kidney constraints may always be met if the lung and liver constraints are met, which may be the case. The example equations derived from Equation (6) and which are graphed in FIG. 3B are:

$${A}_{Z} = \frac{( {λ}_{Z , i} + {μ}_{i} ) \frac{{α}_{i}}{{β}_{i}}}{2 {λ}_{Z , i} {d}_{Z , i}^{2}} ( - {d}_{Z , i} + \sqrt{{d}_{Z , i}^{2} - 4 \frac{{λ}_{Z , i} {d}_{Z , i}^{2}}{( {λ}_{Z , i} + {μ}_{i} ) \frac{{α}_{i}}{{β}_{i}}} ( \begin{matrix}{A}_{B} {d}_{B , i} + \\ \frac{{λ}_{B , i} {A}_{B}^{2} {d}_{B , i}^{2}}{( {λ}_{B , i} + {μ}_{i} ) \frac{{α}_{i}}{{β}_{i}}} - {MTBED}_{i}\end{matrix} )} ) \qquad ( 8 )$$

where the index i can stand for any dose-limiting organ (lungs, liver and kidneys in FIG. 3B).

Referring to FIG. 3A and 3B, any combination of A_{B} and A_{Z} whose corresponding point on the graph is located within the bounds of the 2 axes and the solid colored lines may deliver less than or an equal amount to the dose-limiting organs (or MTBEDs) of dose (or BED) to the normal organs. Concretely, in the case where a combination of two BED-based constraints (lungs and liver, as illustrated in FIG. 3B) will be used, the intersection of the two curves (A_{Bint}, A_{Zint}) may be found be setting Equation (8) for liver (li) equal to equation (8) for lungs (lu) and solving for A_{B} and substituting in either organ version of equation (8) to obtain A_{Z}. These activity values (A_{Bint}, A_{Zint}) from the intersection point will deliver the MTBED to both organs, lungs and liver. In theory, an algebraic formulation of A_{Bint} (and A_{Zint}) may be derived; however, the formula is a 4^{th} order polynomial and it may be much simpler to arrive at the solution numerically.

The intersection values for A_{B} and A_{Z} maximize the BED to the constraining organs, but it does not necessarily follow that those are the desired or optimal activities to administer, since normal organs are not the target of the radiopharmaceutical therapy. Ultimately, a radiobiological parameter which translates the effect of the administered activities upon the target, i.e., the tumor(s), is the quantity which may be maximized. Intuitively, the intersection point may represent a probable good first order estimate of this optimization point. However, for a more rigorous optimization, the target quantity to be maximized may need to be determined and then calculated and plotted as a function of A_{B} and A_{Z} taken along the solid path plotted in FIG. 3B. The application of this concept is demonstrated using (a) the tumor BED and (b) the disease EUD for multiple tumors.

Details of optimizing the tumor BED, as set forth in 215 of FIG. 2, are now explained. Optimize tumor BED module 135 may be used to help accomplish 215, and may comprise the following functions. While the tumor is a more complex object than a normal organ from a radiobiological standpoint and a single dosimetric value such as the mean BED is not expected to be predictive of response in tumors that have a non-uniform absorbed dose distribution and, depending upon tumor size, a spatially variable radiosensitivity, it may remain a reasonable first order measure of response for smaller tumors, assuming that the value may be determined with enough accuracy. Moreover, more predictive radiobiological quantities applicable to larger heterogeneous tumors, such as surviving fraction, EUD and tumor control probability may all be derived from BED values, which may be taken at the voxel level and any methodology based on BED optimization may easily be extended to those other, more comprehensive radiobiological parameters. As a first order single value response or activity escalation criterion, the BED may be superior to administrated activity or even absorbed dose and efforts may be made to base radiopharmaceutical therapy treatment strategies on the BED.

The expression of the tumor BED may be a variation of Equation (6), where the (turn) subscript stands for the tumor:

$${BED}_{tum} = ( {A}_{Z} {d}_{Z , tum} + {A}_{B} {d}_{B , tum} ) ( 1 + {G ( ∞ )}_{tum} \cdot \frac{{A}_{Z} {d}_{Z , tum} + {A}_{B} {d}_{B , tum}}{{α}_{tum} / {β}_{tum}} ) \qquad ( 9 )$$

The values of BEDₜᵤₘ as a function of A_{B} may be obtained by substituting the expression for A_{Z} from the organ-appropriate version of Equation (8) into Equation (9). That is, in the example illustrated in FIG. 3B, by using the liver constraint (Equation (8)) for A_{B}<A_{Bint} and the lung constraint (Equation (8)) for A_{B}≧A_{Bint}, the dependence of the tumor BED as a function of A_{B} may be obtained and thus the optimal value for A_{B} (and consequently A_{Z}). The calculation of G(∞)ₜᵤₘ may no longer be trivial, however, as it depends on the sum of the dose-rate contributions from both the ¹³¹I-tositumomab (B) and ⁹⁰Y-ibritumomab tiuxetan (Z) whose uptake in tumor may be described as a two-component exponential fit as shown in Equation (10):

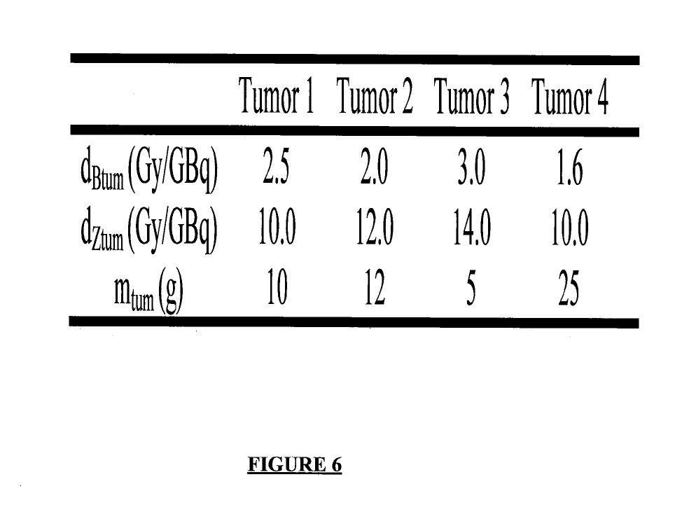

\dot{D}(t)=\dot{D}_{0,B}(1−e^{-κ}^{_{B}}^{t})e^{-λ}^{_{B}}^{t}+\dot{D}_{0,Z}(1−e^{-κ}^{_{Z}}^{t})e^{-λ}^{_{Z}}^{t} (10)

where the κ parameters are the uptake constants, for example, on the order of 24-48 hours. Although the biological uptake and clearance rates may be assumed to be the same, since ¹³¹I and ⁹⁰Y have different physical half-lives, the κ and λ values may be different for each isotope. For purposes of illustration, we may assume a biological half-life, T_{λbio} of 4 days and a biological uptake, T_{κbio} of 48 hours, values typically seen in clinical dosimetry, and the ¹³¹I and ⁹⁰Y dose rate constants may be calculated as shown in Equation (11):

$$\{ \begin{matrix}{λ}_{i} = \frac{ln 2}{{T}_{{ϕ}_{i}}} + \frac{ln 2}{{T}_{λ bio}} \\ {κ}_{i} = \frac{ln 2}{{T}_{{ϕ}_{i}}} + \frac{ln 2}{{T}_{κ bio}}\end{matrix} \} \qquad ( 11 )$$

where the index i may be valid for both B and Z and T_{100 i} may be the physical half-life of the isotope: 64.0 hours for Z (⁹⁰Y) and 8.02 days for B (¹³¹I). By integrating the two terms in Equation (10) separately, the parameters \dot{D}_{0,i} may be solved for, as shown in Equation (12):

$${\dot{D}}_{0 , i} = {D}_{i} \frac{{λ}_{i} ( {λ}_{i} + {κ}_{i} )}{{κ}_{i}} \qquad ( 12 )$$

where Dᵢ may be the absorbed dose for the isotope i. Example values for Dᵢ are listed in the table of FIG. 6 (which illustrates parameters for disease EUBED-based optimization) as dₜᵤₘ: the absorbed dose per unit activity. By substituting Equation (10) into Equation (3) the G-factor may be obtained. A rigorous expression for the G-factor for multi-component exponentials from several sources may be found (e.g., see Baechler S. et al., Extension of the biological effective dose to the MIRD schema and possible implications in radionuclide therapy dosimetry. Med Phys. March 2008; 35(3):1123-1134, which is herein incorporated by reference), or the expression may be calculated numerically as was done here.

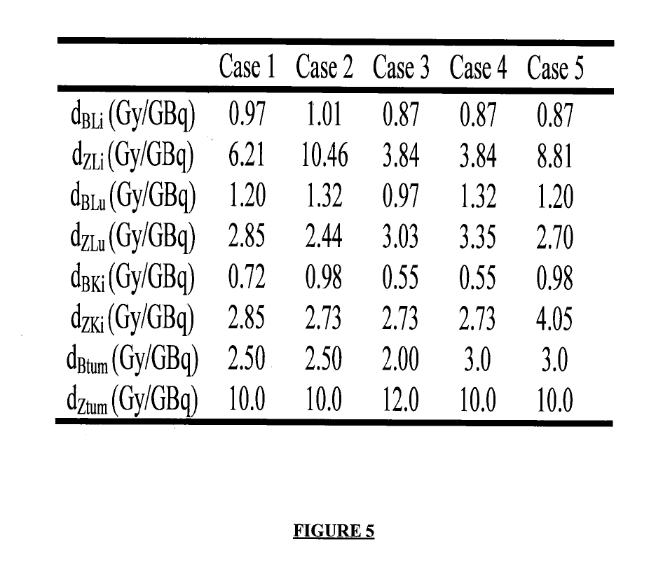

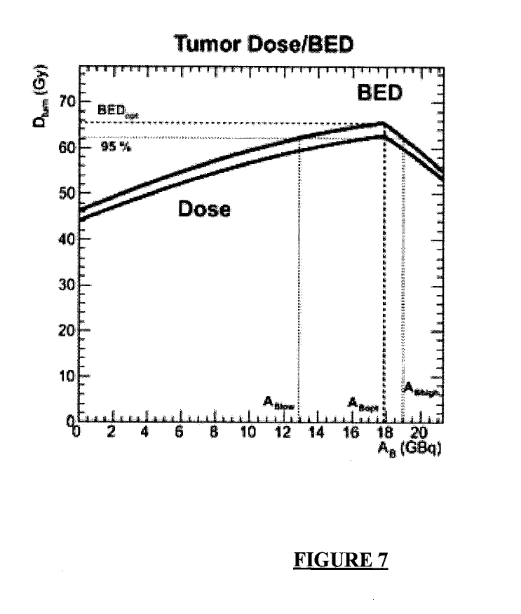

The tumor BED as a function of A_{B} may be illustrated in FIG. 7 (which illustrates tumor BED-based optimization) for the same case as shown in FIG. 3B and using the same normal organ parameters as shown in the table in FIG. 5. The tumor dose and BED may be plotted in FIG. 6 as a function of A_{B}.

As shown in FIG. 7, the optimal A_{B} value for tumor control matches that obtained at the intersection of the two MTBED curves (FIGS. 3A and 3B). It follows that the same is true for A_{Z}.

Details of the multiple tumor optimization, as set forth in 220 of FIG. 2, are now explained. Optimize multiple tumors module 145 may be used to help accomplish 220, and may comprise the following functions. Since the optimization point depends on tumor kinetics, it is quite possible for a patient with more than one tumor to have different optimal combinations for the different tumors. In these instances, the notion of equivalent uniform BED (EUBED) may be used to optimize the activities relative to multiple tumors. The EUBED may be given by example Equation (13):

$$EUBED = - \frac{1}{α} ln ( \frac{{\sum }_{i = 1}^{N} {e}^{- α {BED}_{i}}}{N} ) \qquad ( 13 )$$

for equally contributing N components (e.g., voxels) of a single tumor. This expression may easily be extended to several tumors in example Equation (14):

$$EUBED = - \frac{1}{α} ln ( \frac{{\sum }_{i = 1}^{N} {w}_{i} {e}^{- α {BED}_{i}}}{{\sum }_{i = 1}^{N} {w}_{i}} ) \qquad ( 14 )$$

where the weighting factor, wᵢ, is proportionate to the preponderance (mass) of the tumor and i now iterates over the number of tumors, N. This approach may be illustrated by considering 4 tumors using a case of normal organ kinetics. The normal organ parameters may be the same for all tumors, since they are from the same patient (e.g., the table in FIG. 5, Case 3). The tumor parameters may be given in the table in FIG. 6 and may be chosen from within the ranges given in the literature. The masses may be arbitrarily selected for illustrative purposes. The optimization process may be essentially the same as for a single tumor: as A_{B} varies from 0 to A_{Bmax}, the appropriate organ-specific version of Equation (8) for A_{Z} may be substituted into Equation (9) for each tumor. Once the different tumor BEDs are calculated, the disease EUBED may be obtained using Equation (13) and the results may be plotted, from which the optimal A_{Bopt} (and A_{Zopt}) value is determined. Note that this approach may also be used for single heterogeneous tumors as previously discussed.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages are presented for example purposes only The disclosed methodology and system are each sufficiently flexible and configurable such that they may be utilized in ways other than that shown. For example, any of the elements of FIG. 1 or FIG. 2 may be omitted.

Although the term “at least one” may often be used in the specification, claims and drawings, the terms “a”, “an”, “the”, “said”, etc. also signify “at least one” or “the at least one” in the specification, claims and drawings. In addition, the terms “comprising,” “including” and similar terms signify “including, but not limited to.”

Finally, it is the applicant's intent that only claims that include the express language “means for” or “step for” be interpreted under 35 U.S.C. 212, paragraph 6. Claims that do not expressly include the phrase “means for” or “step for” are not to be interpreted under 35 U.S.C. 212, paragraph 6.

1. A method of treating a disease for a patient, comprising:
performing processing associated with assigning, using a processing device, class data related to a class of patients that have characteristics similar to a specific patient and/or accessing patent data related to the specific patient;
performing processing associated with optimizing, using the processing device, a treatment plan, the optimizing being determined utilizing: properties of a radiopharmaceutical used to treat the patient; and the class data and/or the patient data.

2. The method of claim 1, wherein the class data and/or the patient data comprises: tumor properties; normal organ characteristics; organ and/or tumor imaging; organ and/or tumor measurement data; literature data; clinical data; pre-clinical data; or in vivo processing data; or any combination thereof.

3. The method of claim 1, wherein the properties comprise: emissions range data; emission type data; half-life data; radiopharmaceutical metabolism data; routed excretion data; emissions spectrum data; emissions energy data; data related to timing and repetition of administration of the pharmaceutical; or treatment schedule data; data related to different routes of administration; or any combination thereof.

4. The method of claim 1, wherein the treatment plan is optimized using more than one radiopharmaceutical.

5. The method of claim 1, wherein the treatment plan is updated over a time frame based on how the class data and the patient data changes over time.

6. The method of claim 5, wherein the time frame comprises: hours, days, months, or years, or any combination thereof.

7. The method of claim 1, wherein the disease comprises: an immunological disease, an infectious disease, cancer, arthritis, or tuberculosis, or any combination thereof.

8. The method of claim 1, wherein betas of different energy are utilized.

9. The method of claim 1, wherein the following are utilized:
radiopharmaceuticals emitting beta-particles, alpha-particles, or auger electrons, or any other radiopharmaceutical that is comprised of a targeting component and any radioactive atom or atoms, or any combination thereof.

10. The method of claim 1, wherein the class data and/or patient data also comprises: biological therapy information, chemotherapy information, targeted pharmaceutical information, deoxyribonucleic acid (DNA) repair pathway information, anti-metabolite use information, dosimetry information, biological response modifiers, anti-vascular agents, anti-inflammatory agents, signal transduction pathway inhibitors, or stem cell support level dose information, or any combination thereof.

11. A system for treating a disease for a patient, comprising:
a processing device, the processing device configured for:
performing processing associated with assigning, using the processing device, class data related to a class of patients that have characteristics similar to a specific patient and/or accessing patent data related to the specific patient;
performing processing associated with optimizing, using the processing device, a treatment plan, the optimizing being determined utilizing: properties of a radiopharmaceutical used to treat the patient; and the class data and/or the patient data.

12. The system of claim 11, wherein the class data and/or the patient data comprises: tumor properties; normal organ characteristics; organ and/or tumor imaging; organ and/or tumor measurement data; literature data; clinical data; pre-clinical data; or in vivo processing data; or any combination thereof.

13. The system of claim 11, wherein the properties comprise: emissions range data; emission type data; half-life data; radiopharmaceutical metabolism data; routed excretion data; emissions spectrum data; emissions energy data; data related to timing and repetition of administration of the pharmaceutical; or treatment schedule data; data related to different routes of administration; or any combination thereof.

14. The system of claim 11, wherein the treatment plan is optimized using more than one radiopharmaceutical.

15. The system of claim 11, wherein the treatment plan is updated over a time frame based on how the class data and the patient data changes over time.

16. The system of claim 15, wherein the time frame comprises: hours, days, months, or years, or any combination thereof.

17. The system of claim 11, wherein the disease comprises: an immunological disease, an infectious disease, cancer, arthritis, or tuberculosis, or any combination thereof.

18. The system of claim 11, wherein radiopharmaceuticals emitting beta-, alpha- or auger electron particles of different energy are utilized.

19. The system of claim 11, wherein the following are utilized:
radiopharmaceuticals emitting betas, alphas, or augers, or any combination thereof.

20. The system of claim 11, wherein the class data and/or patient data also comprises: biological therapy information, chemotherapy information, targeted pharmaceutical information, deoxyribonucleic acid (DNA) repair information, anti-metabolite use information, dosimetry information, biological response modifiers, anti-vascular agents, anti-inflammatory agents, signal transduction pathway inhibitors, or stem cell support level dose information, or any combination thereof.
